(19) United States
(12) Patent Application Publication
(10) Pub. No.: US 2009/0167133 A1
(43) Pub. Date: Jul. 2, 2009

(54) ELECTRONIC TUBE

(76) Inventor: Oliver Heuermann, Hemhofen (DE)

Correspondence Address: BRINKS HOFER GILSON & LIONE, P.O. BOX 10395, CHICAGO, IL, 60610, US

(21) Appl. No.: 12/335,120

(22) Filed: Dec. 15, 2008

(30) Foreign Application Priority Data
Dec. 21, 2007 (DE) DE102007062 054.5

(51) Int. Cl. H01J 7/44

(52) U.S. Cl. 313/10

(57) ABSTRACT

An electronic tube and an improved system for actuating the electrodes and/or the heating of a tube and for determining the service life of a tube is provided. The electronic tube has an evacuated or gas-filled region, in which one or several electrodes as well as a device for measuring the temperature of one of the electrodes are arranged. The electrode temperature of a tube may be precisely determined with relatively little effort. The service life of the tube may be predicted more precisely. By monitoring the electrode temperature and correspondingly actuating the electrodes and/or the electrode heating, it is possible to keep the electrode temperature precisely to the desired value (target value).

This patent document claims the benefit of DE 10 2007 062 054.5, filed Dec. 21, 2007, which is hereby incorporated by reference.

### BACKGROUND

The present embodiments relate to an electronic tube.

Electronic tubes, such as vacuum electronic tubes, have a limited service life. One factor that influences the service life is the emission capability of the cathode. The emission capability of the cathode continuously deteriorates during operation of a tube with a directly or indirectly heated cathode. The cathode continuously deteriorates as a result of the electron-emitting material evaporating. The deterioration can be expressed by the heating wire evaporation rate or the barium evaporation rate.

It is of interest for tubes, which are to be used in highly reliable systems (e.g. in medical devices), to predict the end of the service life precisely and if necessary also to lengthen the service life by selective activation. The determination of the evaporation rate plays a special role, since, in addition to the emission capability of the cathode deteriorating, unwanted secondary effects appear, for example, an electric strength that is reduced by the accumulation of the evaporated material.

To determine the evaporation rate, it is in turn necessary to determine the temperature of the cathode. EP 0 339 714 A1 discloses measuring the value of a temperature-dependent physical variable. A power impulse may be terminated if the value of the temperature-dependent physical variable, by comparison with a reference value, indicates that the temperature of a linear cathode has exceeded a limit value. EP 0 339 714 A1 discloses possible physical variables. EP 0 339 714 A1 mentions tensile load of the cathode wire, length of the cathode wire, spectrum and intensity of the emitted electromagnetic radiation, number of electrons emitted per time unit and the speed distribution thereof as well as the electrical resistance of the cathode wire.

The unexamined patent application DE 199 56 391 A1 proposes determining the cathode temperature of a fluorescent lamp from the electrical resistance, and JP 09245712 A proposes, in order to avoid fusing cathode wires, monitoring the drop in voltage by the cathode and correspondingly controlling the drive voltage.

The problem with these solutions is that the determination of the temperature of the cathode wire only takes place indirectly by measuring another physical variable. Specific inaccuracies with regard to the respective measurement occur here, as with any measurement. Modeling inaccuracies still occur, for example, conclusions about the temperature of a cathode wire will be subject to inaccuracy even where the electrical resistance of a cathode wire has been determined with minimal relative error. The fact that tubes have manufacturing tolerances, relating to the diameter or the length of the cathode wire, is alone enough to cause this. In the case of indirectly heated cathodes, it can occur that the temperature of the heating wire is first determined from the resistance measurement and then the (faulty) assumption is made that the cathode temperature is identical to or deviates by an empirically determined value. Environmental influences and ageing effects also negatively affect the precision of the indirect temperature determination.

U.S. Pat. No. 4,708,677 proposes measuring the temperature of a semiconductor wafer, which is located in a heat cleaning chamber, from the outside (through a window in the chamber wall) using a pyrometer. Such an arrangement appears however not to be practical for electronic tubes, because the exact alignment of the external pyrometer on the cathode in a corresponding device is associated with difficulties and also complicates the compact design of such a device.

### SUMMARY

The present embodiments may obviate one or more of the drawbacks or limitations inherent in the related art. For example, in one embodiment, an electronic tube and an improved system are used for actuating the electrode and/or the heating of a tube as well as to determine the service life of an electronic tube.

In one embodiment, a tube, such as an electronic tube, includes an evacuated or gas-filled region. One or several electrodes and a device for measuring the temperature of one of the electrodes are arranged in the evacuated or gas-filled region.

In one embodiment, the device for measuring the electrode temperature, which is located in the evacuated or gas-filled region of the tube, may include a pyrometric sensor.

To avoid adversely affecting the efficiency of the sensor by the accumulation of materials, which evaporate on the electrodes, provision can be made to protect the sensor or an optical element arranged upstream of the sensor by a seal, which may be opened and/or closed electronically or electromechanically.

A system, which includes a tube, may include a controller and a device for detecting an electrode temperature measured value.

In one embodiment, a controller can be provided, which identifies the impending end of the service life of the tube by continually evaluating the electrode temperature and a heating power supplied to the tube and signalizes this to a user and/or maintenance control center.

In a further embodiment, the system may include a controller that may, additionally or alternatively, continually evaluate the electrode temperature and actuate the electrodes and/or an electrode heating. The electrode and/or the electrode heating may be actuated such that the electrode temperature corresponds to a target value.

The electrode temperature of an electronic tube may be determined with relatively little effort. The service life of the tube may be predicted with greater precision. By monitoring the electrode temperature and correspondingly actuating the electrode and/or the electrode heating, to maintain the electrode temperature precisely at a desired value (target value). This is advantageous since in the case of a klystron, the exceedance of the nominal surface temperature of 890° C. about only 50 K results in an unwelcome doubling of the barium evaporation rate, for example.

### BRIEF DESCRIPTION OF THE DRAWINGS

FIG. 1 shows one embodiment of a gun region of an electronic tube; and

FIG. 2 shows one embodiment of a sensor of a pyrometer for detecting the temperature for use in an electronic tube from FIG. 1.

### DETAILED DESCRIPTION

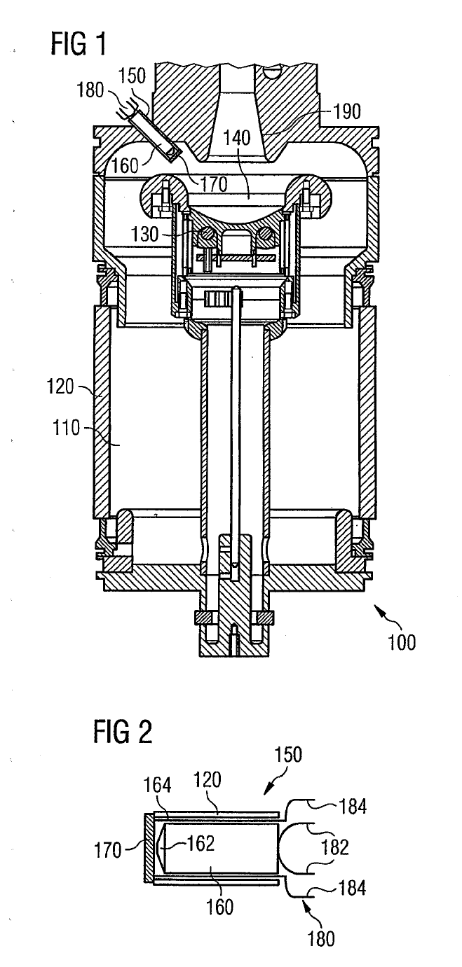

FIG. 1 shows a gun region of a klystron 100. A klystron 100 is an electronic tube, which uses the operating time of the electrons in order to generate or amplify high frequency signals. A housing 120 made of non-conductive, temperature-resistant material, for example, ceramics or glass, surrounds an evacuated region 110. A cathode with a cathode surface 140 is arranged in the evacuated region. The housing 120 is heated by a heater 130. A measuring device 150 for temperature measurement includes a sensor element 160 with a seal 170 and electrical terminals 180. The measuring device 150 protrudes into the evacuated region 110. An anode 190 of the electronic tube 100 is also shown.

FIG. 2 shows further details of the measuring device 150 for measuring the temperature. The measuring device 150 is surrounded by a tube housing 120 and includes the sensor 160. The sensor 160, such as a lens, may be assigned to an optical element 12, for example, in order to achieve a better focus on the region to be detected.

In one embodiment, a central seal 170 may used in order to protect the surface of the optical sensor 160 and/or lens 162. The central seal 170 may prevent evaporation electron-emitting cathode material from accumulating on the cold surface of the optical sensor 160 and/or lens 162. The central seal 170 may include several curved secondary plates, which are pivoted about a fixed point of rotation out of the radiation path. The central seal 170 may be a shutter, as in camera technology, and may be available in large quantities at low prices. The central seal 170 (also known as a shutter) may protect the sensor optics 162 in the phases, in which measurement is not taking place. In order to measure the temperature, the shutter 170, which is located in the vacuum, is electromagnetically actuated and opened from the outside by way of a media gap 164 (barrier made of glass or ceramics between the vacuum of the tube and the ambient pressure. After the measurement, the shutter 170 is closed again.

In one embodiment, the central seal 170 may be a disk with an opening, which rotates during actuation and releases the radiation path to the sensor 160.

The central seal 170 is controlled electromechanically, with the necessary electrical energy being supplied by electrical terminals 184. The signal generated by the sensor 160 is provided at additional terminals 182.

In one embodiment, during operation, the integrated optical measuring arrangement 150 may be used to determine the evaporation rate in the tube 100. A measuring arrangement a surface temperature measurement is periodically implemented by the cathode or anode (e.g. in the case of x-ray tubes, the anode temperature is of great interest). Regulation of the heating may be realized by directly measuring the actual surface temperature.

In one exemplary embodiment, the sensor 160 is a photo semi-conductor. Temperatures from approximately 700° C. may be pyrometrically measured using photodiodes in the visible spectral region. Pyrometers are units which include the sensor 160 and an evaluation unit. Pyrometers are used for the contactless temperature measurement of temperatures between −50° C. and +4000° C. The reception wave length range of high temperature pyrometers is mostly determined by the photo receivers used. The lowest reception wave length of silicon photo diodes may be, for example, approximately 1.1 μm. One element with a temperature of 3000 K has its radiation maximum here, temperatures from approximately 700° C. may however also be measured. The surface temperatures in the case of klystron, magnetron, thyratron, and accelerator range between 890° C. to 1050° C., depending on the cathode type used (oxide or impregnated). The surface temperature of the tungsten heating wire in the case of x-ray tubes is approximately 2000° C.

A more reliable service life prediction may be provided with a minimal increase in costs for the integrated optical measurement arrangement. Slowly developing failures can be identified, since the temperature achieved is reduced with a constantly supplied heating power. An integration of the evaluation in the superordinate controller of the overall system allows service notifications to settle out before the system fails and produces costly downtimes (e.g., predictive maintenance). An arcing probability may be calculated by the evaporation rate determined and the available quantity of barium in the cathode from the start.

The service life of the electronic tube 100 may be intentionally extended. With the aid of the exact measurement of the surface temperature, the state (e.g., electronic emission with the currently supplied heating power) of the cathode can be determined and precise heat regulation is derived therefrom. The consequence of precise heat regulation is the significant lengthening of the service life of a tube.

Compared with a likewise possible contact measurement with temperature sensors, the contactless measurement by an optical sensor 160 according to an exemplary embodiment has the following advantages: rapid measurement (<1 ms to up to 10 μs depending on design); wide, continuous measurement ranges possible (e.g. 350° C. to 3500° C.); irrespective of the mechanism of the seal 170, no wear occurs; no temperature influence of the measuring object and no errors as a result of poor thermal contact; and possibility of measurement even with high voltages or strong electromagnetic fields.

The cycle duration, such as the frequency with which the shutter 170 is opened and a temperature measurement is implemented, may be adjusted. For the application within a control loop, the cycle duration will range between a number of seconds or less. For the service life prediction, a cycle duration in minutes or even hours may be sufficient.

The present invention is not restricted to the described exemplary embodiments. It can rather be applied to all types of tubes, preferably to such tubes, the failure of which, as in the medical field, causes high costs as a result of the idle time of an expensive overall system, e.g. x-ray tubes or tubes of the thyratron, klystron, magnetron or accelerator type. The present embodiments can be applied both to the evacuated as well as to the gas-filled tubes, which are identified in the strictest sense not as electronic tubes, because, like with a thyratron, ions function as charge carriers.

It is naturally also conceivable to monitor several electrodes with a sensor device 150 in each instance in a given tube. All types of electrodes may be monitored. The temperature of the electrodes may be decisive or otherwise of interest with regard to the service life of the tube and/or the temperature of which is to be controlled to a target value, in other words directly or indirectly heated cathode, anode, or grid.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A tube comprising:
an evacuated or gas-filled region;
one or several electrodes; and
a measuring device for measuring the temperature of one of the electrodes,
wherein the one or several electrodes and the measuring device are arranged in the evacuated or gas-filled region.

2. The tube as claimed in claim 1, wherein the measuring device includes a pyrometric sensor for measuring the temperature of one of the electrodes.

3. The tube as claimed in claim 2, further comprising a seal that protects the sensor or an optical element arranged upstream of the sensor, wherein the seal being operable to be electronically or electromechanically opened and/or closed.

4. A system comprising:
a controller; and
a tube comprising:
an evacuated or gas-filled region;
one or several electrodes; and
a measuring device for measuring the temperature of one of the electrodes, the one or several electrodes and the measuring device being arranged in the evacuated or gas-filled region,
wherein the controller includes a device for detecting an electrode temperature measured value.

5. The system as claimed in claim 4, wherein the controller is operable to identify a preferred service life end of the tube by continually evaluating the electrode temperature and a heating power supplied to the electronic tube.

6. The system as claimed in claim 4, wherein the controller is operable to continuously evaluate the electrode temperature and actuate the electrode and/or an electrode heating, with the actuation of the electrode and/or the electrode heating taking place such that the electrode temperature corresponds to a target value.

7. The system as claimed in claim 5, wherein the controller is operable to provide a signal to a user and/or a maintenance control center that identifies the preferred service life end.
